(19) United States
(12) Patent Application Publication
(10) Pub. No.: US 2014/0249761 A1
(43) Pub. Date: Sep. 4, 2014

(54) CHARACTERIZING UNCHARACTERIZED GENETIC MUTATIONS

(71) Applicant: DNANEXUS, INC., Mountain View, CA (US)

(72) Inventor: Andrew W. CARROLL, Mountain View, CA (US)

(73) Assignee: DNANEXUS, INC., Mountain View, CA (US)

(21) Appl. No.: 14/195,644

(22) Filed: Mar. 3, 2014

Related U.S. Application Data
(60) Provisional application No. 61/771,378, filed on Mar. 1, 2013.

(51) Int. Cl. G06F 19/18

(52) U.S. Cl. CPC G06F 19/18
USPC 702/19

(57) ABSTRACT

An ensemble predictor for characterizing uncharacterized genetic mutations is disclosed. A first set of genomic information representing a particular (e.g., harmful) mutation is obtained. The first set of genomic information is provided to a number of underlying mutation impact predictors. Predictions are obtained from the underlying predictors. The predictions predict whether the first set of genomic information represents the particular mutation. The predictions and the particular (known) mutation are provided to a logistic regression model, which provides a coefficient for each underlying predictor. A second set of (uncharacterized) genomic information is obtained. The second set of genomic information is provided to the underlying predictors. Predictions are obtained from the underlying predictors and are then weighted using the coefficients. A characterization (e.g., as harmful or not) of the second set of genomic information is provided by the ensemble predictor based on the weighted underlying predictions and may be displayed.

### CROSS-REFERENCE TO RELATED APPLICATION

This application claims the benefit of U.S. Provisional Application 61/771,378 filed on Mar. 1, 2013, the content of which is incorporated herein by reference for all purposes.

### BACKGROUND

1. Field

The present disclosure relates generally to bioinformatics, and more specifically to systems and methods for characterizing the effects of gene mutations.

2. Description of Related Art

It is believed that genetic mutations such as single-nucleotide polymorphisms can be harmful, beneficial, or non-functional in terms of biological effect. For instance, some genetic mutations are believed to be linked to human diseases, such as cancer and other genetic disorders. Other genetic mutations are believed to affect biological processes, such as metabolism and disease resistance. Yet other genetic mutations have no discernible biological effect. It would be advantageous to be able characterize (e.g., predict) whether one or more specific genetic mutations, whose effect is not yet known, would have an effect on human biology.

Genomics researchers sequence human genomes and exomes to facilitate research to this end. In some instances, sequence data are obtained from patients or family members of patients who are suffering from a genetic disorder. Based on the sequence data, it is hoped that associative gene mutations for the genetic disorder can be identified, such that the associative mutations can be used in the future to screen for the genetic disorder in others.

One difficulty in this research lies in the fact that the genome of an individual human being contains hundreds of thousands of positions that could be considered as mutations relative to a reference human genome, and yet not be associated with any particular disorder or other biological difference. Thus, it is difficult to identify exactly which mutations are associated with genetic disorders.

### BRIEF SUMMARY

In one embodiment, a computer-enabled method of characterizing uncharacterized mutations in a set of genomic information using a plurality of predictors comprises: obtaining a first set of genomic information representing a particular mutation; providing the first set of genomic information to each predictor of the plurality of predictors; obtaining, from the plurality of predictors, a first plurality of predictions, where a prediction of the first plurality of predictions predicts whether the first set of genomic information represents the particular mutation; providing, to a logistic regression model, the first plurality of predictions; identifying, to the logistic regression model, that the first plurality of predictions represents the particular mutation; obtaining, from the logistic regression model, a coefficient for each prediction of the first plurality of predictions; obtaining a second set of genomic information; providing the second set of genomic information to at least one predictor of the plurality of predictors; obtaining, from the plurality of predictors, a second plurality of predictions, where a prediction of the second plurality of predictions predicts whether the second set of genomic information represents the particular mutation; determining, based on the obtained plurality of coefficients and the obtained second plurality of predictions, whether the second set of genomic information represents the particular mutation; and causing to be displayed, via a network, the determination.

In one embodiment, a non-transitory computer-readable medium has computer-executable instructions, where the computer-executable instructions, when executed by one or more processors, cause the one or more processors to characterize uncharacterized mutations in a set of genomic information using a plurality of predictors. The computer-executable instructions comprise instructions for: obtaining a first set of genomic information representing a particular mutation; providing the first set of genomic information to each predictor of the plurality of predictors; obtaining, from the plurality of predictors, a first plurality of predictions, where a prediction of the first plurality of predictions predicts whether the first set of genomic information represents the particular mutation; providing, to a logistic regression model, the first plurality of predictions; identifying, to the logistic regression model, that the first plurality of predictions represents the particular mutation; obtaining, from the logistic regression model, a coefficient for each prediction of the first plurality of predictions; obtaining a second set of genomic information; providing the second set of genomic information to at least one predictor of the plurality of predictors; obtaining, from the plurality of predictors, a second plurality of predictions, where a prediction of the second plurality of predictions predicts whether the second set of genomic information represents the particular mutation; determining, based on the obtained plurality of coefficients and the obtained second plurality of predictions, whether the second set of genomic information represents the particular mutation; and causing the determination to be displayed.

In one embodiment, a system for characterizing uncharacterized mutations in a set of genomic information using a plurality of predictors comprises: a network interface configured to connect to a network; one or more processors operatively coupled to the network interface and configured to: obtain a first set of genomic information representing a particular mutation; provide the first set of genomic information to each predictor of the plurality of predictors over the network; obtain, over the network from the plurality of predictors, a first plurality of predictions, where a prediction of the first plurality of predictions predicts whether the first set of genomic information represents the particular mutation; provide, to a logistic regression model, the first plurality of predictions; identify, to the logistic regression model, that the first plurality of predictions represents the particular mutation; obtain, from the logistic regression model, a coefficient for each prediction of the first plurality of predictions; obtain a second set of genomic information; provide the second set of genomic information to at least one predictor of the plurality of predictors over the network; obtain, over the network from the plurality of predictors, a second plurality of predictions, where a prediction of the second plurality of predictions predicts whether the second set of genomic information represents the particular mutation; determine, based on the obtained plurality of coefficients and the obtained second plurality of predictions, whether the second set of genomic information represents the particular mutation; and transmit the determination via the network for display.

In some embodiments, the plurality of predictors consists of only SIFT, MUTATIONASSESSOR, and GERP. In some embodiments, the plurality of predictors consists of only SIFT, MUTATIONASSESSOR, LRT, MUTATIONTASTER, PHYLOP, and GERP. In some embodiments, the plurality of predictors comprises SIFT, MUTATIONASSESSOR, GERP, and so forth, but not CONDEL nor POLYPHEN. In some embodiments, the plurality of predictors comprises SIFT, MUTATIONASSESSOR, GERP, and so forth, but not CONDEL. In some embodiments, the plurality of predictors comprises SIFT, POLYPHEN, MUTATIONASSESSOR, GERP, and so forth, but not CONDEL. In some embodiments, the plurality of predictors comprises SIFT, POLYPHEN, MUTATIONASSESSOR, LRT, MUTATIONTASTER, PHYLOP, GERP, and so forth, but not CONDEL.

### DESCRIPTION OF THE FIGURES

FIG. 1 depicts an exemplary system for characterizing uncharacterized gene mutations.

FIG. 2 depicts an exemplary process for characterizing uncharacterized gene mutations.

FIG. 3 depicts an exemplary computing system.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

The embodiments described herein include an ensemble predictor for characterizing whether a particular gene mutation is harmful. Embodiments of the ensemble predictor characterize a window of gene mutation(s) using particular combinations of underlying mutation impact predictors, such as SIFT, POLYPHEN, MUTATIONASSESSOR, CONDEL, LRT, MUTATIONTASTER, PHYLOP, GERP, and so forth (each of which is described in greater detail below). The ensemble predictor weighs the outputs of the underlying mutation impact predictors in order to arrive at an overall characterization for the particular gene mutation. Numeric weights may be used to favor or disfavor the output of specific underlying mutation impact predictors based on the ensemble predictor's perception of the accuracy of each specific underlying mutation impact predictor. In this way, the ensemble predictor provides more accurate characterizations than known predictors, including the underlying mutation impact predictors that are used by the ensemble predictor.

As used herein, the term “gene mutation” includes single-nucleotide polymorphisms. The term “predictor” refers to a mutation impact predictor (e.g., those that may be used as underlying mutation impact predictors by the ensemble predictor). One of ordinary skill in the art would recognize that the exemplary underlying mutation impact predictors given above may change in name or implementation from time to time. The ensemble predictor can account for these changes in underlying mutation impact predictors. For instance, should future changes to an underlying mutation impact predictor negatively impact the predictor's accuracy, the ensemble predictor may assign a lower numeric weight for that underlying predictor so as to reduce the effect of the underlying predictor on the overall output of the ensemble predictor.

It should be noted that the ensemble predictor does not necessarily improve in accuracy based on the sheer number of underlying mutation impact predictors that are used. Rather, the combination of certain specific underlying mutation impact predictors is found to provide superior accuracy. For instance, the inclusion of POLYPHEN into the ensemble predictor provides only a low improvement over the other underlying predictors that are discussed below, and the inclusion of CONDEL is redundant if SIFT, MUTATIONASSESSOR, and GERP are already used. These findings, however, should not be read as precluding future improvements to the ensemble predictor that includes additional underlying predictors. Rather, they are important to an efficient ensemble predictor that is also accurate.

The accessing of mutation impact predictors such as SIFT, POLYPHEN, MUTATIONASSESSOR, CONDEL, LRT, MUTATIONTASTER, PHYLOP, and/or GERP over the internet should be within the skill of one of ordinary skill in the art. SIFT (i.e., sorts intolerant from tolerant amino acid substitution) predicts whether an amino acid substitution affects protein function, and is provided by the J. Craig Venter Institute. POLYPHEN (i.e., Polymorphism Phenotyping) predicts possible impact of an amino acid substitution on the structure and function of a human protein. See Adzhubei I A, Schmidt S, Peshkin L, Ramensky V E, Gerasimova A, Bork P, Kondrashov A S, Sunyaev S R. Nat Methods 7(4):248-249 (2010). MUTATIONASSESSOR predicts the functional impact of amino-acid substitutions in proteins, and is provided by the Memorial Sloan Kettering Cancer Center. CONDEL (i.e., CONsensus DELeteriousness score of missense SNVs) is an ensemble predictor of mutation impact, and is provided by University Pompeu Fabra. LRT refers to a “likelihood ratio test” that identifies a subset of deleterious (i.e., harmful) mutations that disrupt highly conserved amino acids within protein-coding sequences, which are likely to be unconditionally deleterious. See Chun S, Fay J C, “Identification of deleterious mutations within three human genomes,” Genome Res., 2009 September; 19(9):1553-61 (2009). MUTATIONTASTER evaluates disease-causing potential of sequence alterations, and is provided by the Charité-Universitätsmedizin Berlin. PHYLOP computes conservation or acceleration p-values based on an alignment and a model of neutral evolution, and is provided by Cornell University. GERP (i.e., Genomic Evolutionary Rate Profiling) identifies constrained elements in multiple alignments by quantifying substitution deficits, and is provided by Stanford University. In some embodiments, the ensemble predictor averages conversation scores from GERP over a window around a mutation as a representation of how quickly the gene region around the mutation is changing over evolutionary time.

In some embodiments, the ensemble predictor uses a logistic regression model to derive the numeric weights that should be assigned to each underlying predictor in the ensemble predictor. The numeric weights may be represented by numeric coefficients. The logistic regression model may be provided by a machine learning package. In some embodiments, the logistic regression model is provided by a machine learning package known as WEKA (i.e., Waikato Environment for Knowledge Analysis), which was developed at the University of Waikato, New Zealand.

A training data set may be provided to the machine learning package so that the machine learning package can apply a logistic regression model to the data to obtain numeric coefficients that correspond to the logistic regression model's predictor variables, which, here, correspond to the underlying mutation impact predictors that are used by the ensemble predictor. The training data set may include a positive data set and a negative data set. Positive training data, which includes gene mutations that are generally considered harmful, may be obtained from the Online Mendelian Inheritance in Man (OMIM) database as well as other locus-specific databases. Negative training data, which includes gene mutations that are generally considered not harmful (e.g., non-functional or even beneficial), can include commonly observed mutations across human populations.

It should be noted that the use of a logistic regression model permits the ensemble predictor to characterize a particular window of gene mutations even if an underlying mutation impact predictor that is used by the ensemble predictor fails to provide a prediction to the ensemble predictor. When multiple underlying predictors are used together with a logistic regression model, the unique information that each underlying predictor provides has multiple redundancies (e.g., the output of the other underlying predictors) such that the elimination of any single predictor need not decrease overall accuracy.

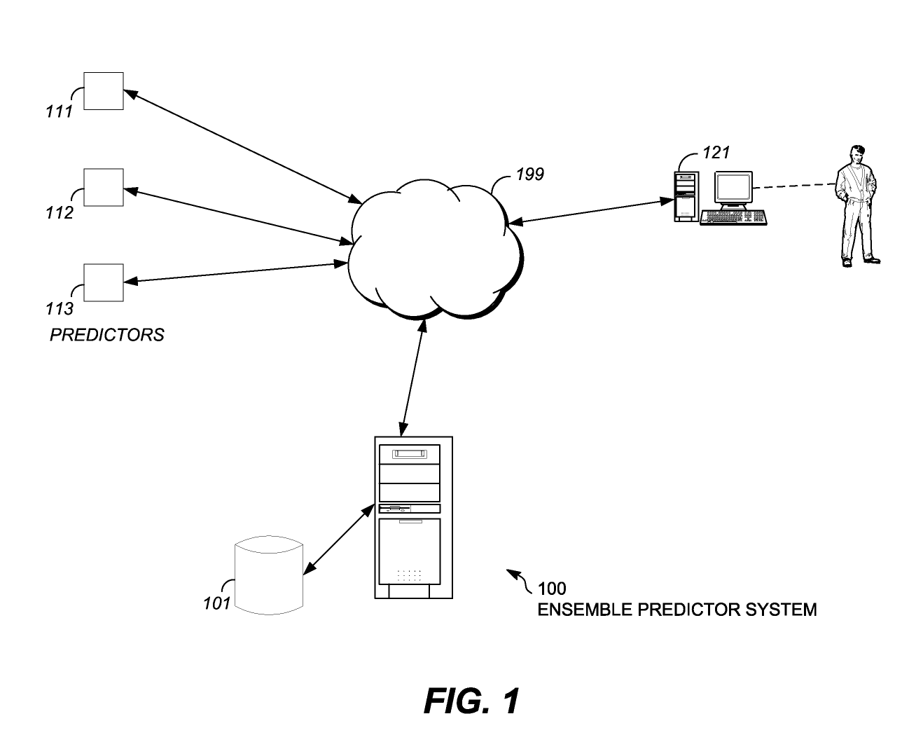

FIG. 1 depicts an exemplary environment in which ensemble predictor system 100 performs ensemble prediction of gene mutations. Ensemble predictor system 100, which includes bioinformatics database 101, may communicate with underlying mutation impact predictors 111-113 via network 199. In addition, computer terminal 121 may communicate with ensemble predictor system 100 via network 199. Computer terminal 121 may query ensemble predictor system 100 regarding a particular gene mutation. Ensemble predictor system 100 may in turn query underlying mutation impact predictors 111-113 regarding the particular gene mutation. Output from underlying mutation impact predictors 111-113 may be processed by ensemble predictor system 100 in order to provide computer terminal 121 with an overall characterization of the gene mutation. Network 199 may be a public network, a private network, or a combination of the two. For example, network 199 may include portions of the internet.

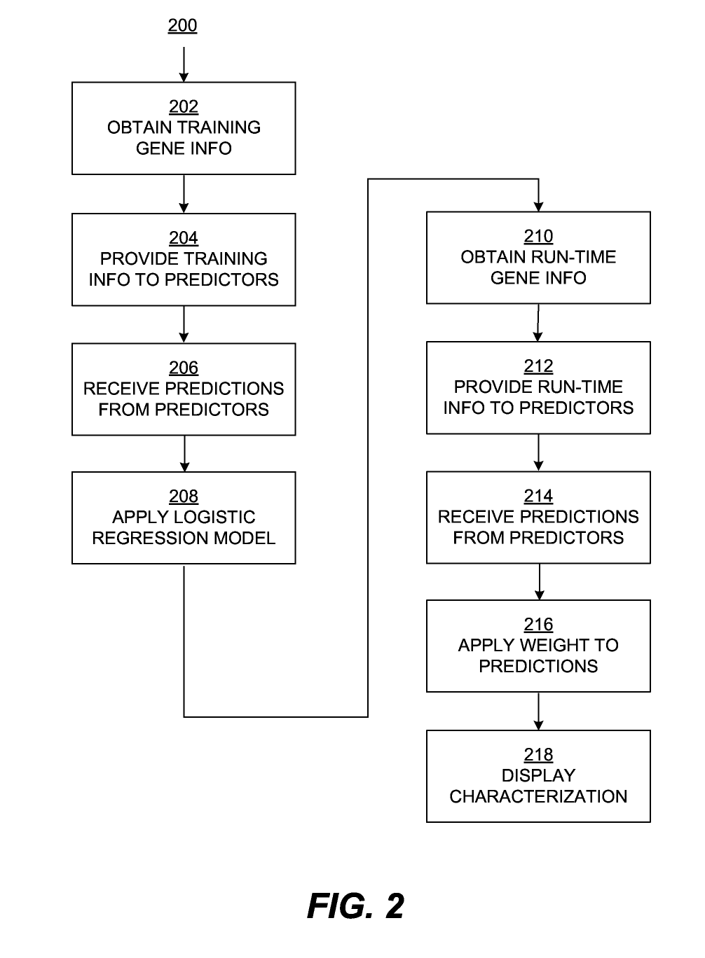

FIG. 2 depicts exemplary process 200 for performing an ensemble prediction to characterize an uncharacterized gene mutation(s) in some embodiments. Within process 200, blocks 202-208 may be referred to as a training sub-process and blocks 210-218 may be referred to as a run-time sub-process.

At block 202, the ensemble predictor receives genomic information representing gene mutations. The effect of the represented gene mutation is “known” in that the gene mutation is either generally considered to be associated with a genetic disorder, thus making the received genomic information a set of positive training data, or generally considered to be not harmful (e.g., non-functional or beneficial), thus making the received genomic information a set of negative training data. At block 204, the received genomic information is provided to multiple underlying mutation impact predictors. At block 206, predictions are received from the underlying mutation impact predictors. The received predictions, along with the known effect of the received genomic information (obtained in block 202) are provided to a logistic regression modeler. At block 208, the ensemble predictor obtains, from the logistic regression modeler, numeric coefficients that correspond to each of the underlying mutation impact predictors that were used at block 204. Blocks 202-208 may be repeated for other known gene mutations so that the ensemble predictor becomes trained based on additional known gene mutations.

At block 210, the ensemble predictor receives another set of genomic information that represents “unknown” gene mutations, meaning that the effect of the gene mutations is not generally understood and/or has not yet been characterized by the ensemble predictor. At block 212, the received genomic information is provided to the same underlying impact predictors that were used at block 204. At block 214, predictions are received from the underlying mutation impact predictors. The received predictions are weighted according to the numeric weights that were obtained at block 208. At block 216, the ensemble predictor determines a weighted prediction that represents the ensemble predictor's characterization of the unknown gene mutations as being harmful or not. At block 218, the ensemble predictor makes the characterization available for display. Blocks 210-218 may be repeated to characterize other unknown gene mutations.

As discussed above, mutation impact predictors such as SIFT, POLYPHEN, MUTATIONASSESSOR, CONDEL, LRT, MUTATIONTASTER, PHYLOP, GERP are available as underlying predictors. In some embodiments, the ensemble predictor uses only SIFT, MUTATIONASSESSOR, and GERP. In some embodiments, the ensemble predictor uses only SIFT, MUTATIONASSESSOR, LRT, MUTATIONTASTER, PHYLOP, and GERP. In some embodiments, the ensemble predictor uses SIFT, MUTATIONASSESSOR, GERP, and so forth, but not CONDEL. In some embodiments, the ensemble predictor uses SIFT, MUTATIONASSESSOR, GERP, and so forth, but not CONDEL nor POLYPHEN. In some embodiments, the ensemble predictor uses SIFT, POLYPHEN, MUTATIONASSESSOR, GERP, and so forth, but not CONDEL. In some embodiments, the ensemble predictor uses SIFT, POLYPHEN, MUTATIONASSESSOR, LRT, MUTATIONTASTER, PHYLOP, GERP, and so forth, but not CONDEL.

In some embodiments, 20,000 gene mutations that are generally considered to be harmful are split 90/10 into a training data set and a testing data set, respectively, to evaluate the accuracy of the ensemble predictor and underlying mutation impact predictors. Embodiments of the ensemble predictor are accurate up to 88% comparing a test set of OMIM mutations against mutations at 5-10% frequency in the population, which represents up to 8% in terms of improvement over the accuracies of the individual underlying mutation impact predictors that can be used by the ensemble predictor.

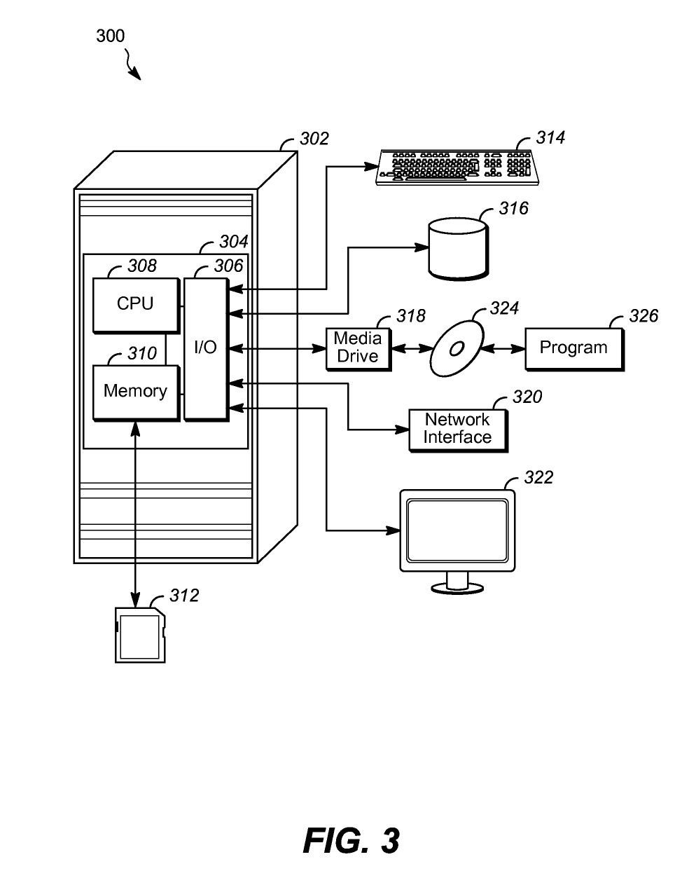

FIG. 3 depicts an exemplary computing system 300 configured to perform parts or all of process 200 (FIG. 2). In this context, computing system 300 may include, for example, a processor, memory, storage, and input/output devices (e.g., monitor, keyboard, disk drive, Internet connection, etc.). However, computing system 300 may include circuitry or other specialized hardware for carrying out some or all aspects of the processes. In some operational settings, computing system 300 may be configured as a system that includes one or more units, each of which is configured to carry out some aspects of the processes either in software, in hardware, or in some combination thereof. Note, the training aspects of process 200 (i.e., blocks 202-208) and the run-time aspects of process 200 (i.e., blocks 210-218) may be implemented onto the same, or onto physically separate, computing systems, each of which may be based on computing system 300.

As shown in FIG. 3, main system 302 includes motherboard 304 having input/output (I/O) section 306, one or more central processing units (CPUs) 308, and memory section 310, which may have flash memory card 312 related to it. The I/O section 306 may be connected to keyboard 314, disk storage unit 316, media drive unit 318, network interface 320, and/or display 322. Media drive unit 318 can read/write a non-transitory computer-readable medium 324, which can contain computer-readable program(s) 326 and/or data.

At least some values based on the results of the above-described processes can be saved for subsequent use. For example, portions of genomic data can be stored in memory (e.g., Random Access Memory), disk storage unit 316, and/or computer-readable medium 324. Portions of genomic data can also be written to a cloud storage device via network interface 320.

Computer-readable medium 324 can be used to store (e.g., tangibly embody) one or more computer program(s) 326 for performing any one of the above-described processes by way of a computer. The computer program(s) may be written, for example, in a general-purpose programming language (e.g., C, C++, Java, JSON, Python) or some specialized application-specific language.

Although only certain exemplary embodiments have been described in detail above, those skilled in the art will readily appreciate that many modifications are possible in the exemplary embodiments without materially departing from the novel teachings and advantages of this invention. Additionally, aspects of embodiments disclosed above can be combined in other combinations to form additional embodiments. Accordingly, all such modifications are intended to be included within the scope of this invention.

What is claimed is:

1. A computer-enabled method of characterizing uncharacterized genetic mutations in a set of genomic information using a plurality of predictors, the method comprising:
obtaining a first set of genomic information representing a particular genetic mutation;
providing the first set of genomic information to each predictor of the plurality of predictors;
obtaining, from the plurality of predictors, a first plurality of predictions, wherein a prediction of the first plurality of predictions predicts whether the first set of genomic information represents the particular genetic mutation;
providing, to a logistic regression model, the first plurality of predictions;
identifying, to the logistic regression model, that the first plurality of predictions represents the particular genetic mutation;
obtaining, from the logistic regression model, a coefficient for each prediction of the first plurality of predictions;
obtaining a second set of genomic information;
providing the second set of genomic information to at least one predictor of the plurality of predictors;
obtaining, from the plurality of predictors, a second plurality of predictions, wherein a prediction of the second plurality of predictions predicts whether the second set of genomic information represents the particular genetic mutation;
determining, based on the obtained plurality of coefficients and the obtained second plurality of predictions, whether the second set of genomic information represents the particular genetic mutation; and
causing the determination to be displayed.

2. The method according to claim 1, wherein:
at least one of the plurality of predictors does not provide a prediction for the second plurality of genomic information.

3. The method according to claim 1, wherein:
the plurality of predictors consists of SIFT, MUTATIONASSESSOR, and GERP.

4. The method according to claim 1, wherein:
the plurality of predictors consists of SIFT, MUTATIONASSESSOR, LRT, MUTATIONTASTER, PHYLOP, and GERP.

5. The method according to claim 1, wherein:
the plurality of predictors comprises SIFT, MUTATIONASSESSOR, and GERP, but not CONDEL nor POLYPHEN.

6. The method according to claim 1, wherein:
the plurality of predictors comprises SIFT, MUTATIONASSESSOR, and GERP, but not CONDEL.

7. The method according to claim 1, wherein:
the plurality of predictors comprises SIFT, POLYPHEN, MUTATIONASSESSOR, and GERP, but not CONDEL.

8. The method according to claim 1, wherein:
the plurality of predictors comprises SIFT, POLYPHEN, MUTATIONASSESSOR, LRT, MUTATIONTASTER, PHYLOP, and GERP, but not CONDEL.

9. The method according to claim 1, wherein:
the particular genetic mutation is a harmful genetic mutation.

10. The method according to claim 1, further comprising:
obtaining, via the network, the first set of genomic information representing the particular genetic mutation from an online database of human genes and genetic phenotypes.

11. The method according to claim 10, wherein:
the online database is the Online Mendelian Inheritance in Man database.

12. A non-transitory computer-readable medium having computer-executable instructions, wherein the computer-executable instructions, when executed by one or more processors, cause the one or more processors to characterize uncharacterized genetic mutations in a set of genomic information using a plurality of predictors, the computer-executable instructions comprising instructions for:
obtaining a first set of genomic information representing a particular genetic mutation;
providing the first set of genomic information to each predictor of the plurality of predictors;
obtaining, from the plurality of predictors, a first plurality of predictions, wherein a prediction of the first plurality of predictions predicts whether the first set of genomic information represents the particular genetic mutation;
providing, to a logistic regression model, the first plurality of predictions;
identifying, to the logistic regression model, that the first plurality of predictions represents the particular genetic mutation;
obtaining, from the logistic regression model, a coefficient for each prediction of the first plurality of predictions;
obtaining a second set of genomic information;
providing the second set of genomic information to at least one predictor of the plurality of predictors;
obtaining, from the plurality of predictors, a second plurality of predictions, wherein a prediction of the second plurality of predictions predicts whether the second set of genomic information represents the particular genetic mutation;
determining, based on the obtained plurality of coefficients and the obtained second plurality of predictions, whether the second set of genomic information represents the particular genetic mutation; and
causing the determination to be displayed.

13. The computer-readable medium according to claim 12, wherein:
at least one of the plurality of predictors does not provide a prediction for the second plurality of genomic information.

14. The computer-readable medium according to claim 12, wherein:
the plurality of predictors consists of SIFT, MUTATIONASSESSOR, and GERP.

15. The computer-readable medium according to claim 12, wherein:
the plurality of predictors consists of SIFT, MUTATIONASSESSOR, LRT, MUTATIONTASTER, PHYLOP, and GERP.

16. The computer-readable medium according to claim 12, wherein:
the plurality of predictors comprises SIFT, MUTATIONASSESSOR, and GERP, but not CONDEL nor POLYPHEN.

17. The computer-readable medium according to claim 12, wherein:
the plurality of predictors comprises SIFT, MUTATIONASSESSOR, and GERP, but not CONDEL.

18. The computer-readable medium according to claim 12, wherein:
the plurality of predictors comprises SIFT, POLYPHEN, MUTATIONASSESSOR, and GERP, but not CONDEL.

19. The computer-readable medium according to claim 12, wherein:
the plurality of predictors comprises SIFT, POLYPHEN, MUTATIONASSESSOR, LRT, MUTATIONTASTER, PHYLOP, and GERP, but not CONDEL.

20. The computer-readable medium according to claim 12, wherein:
the particular genetic mutation is a harmful genetic mutation.

21. The computer-readable medium according to claim 12, wherein the computer-executable instructions further comprise instructions for:
obtaining, via the network, the first set of genomic information representing the particular genetic mutation from an online database of human genes and genetic phenotypes.

22. The computer-readable medium according to claim 21, wherein:
the online database is the Online Mendelian Inheritance in Man database.

23. A system for characterizing uncharacterized genetic mutations in a set of genomic information using a plurality of predictors, the system comprising:
a network interface configured to connect to a network;
one or more processors operatively coupled to the network interface and configured to:
obtain a first set of genomic information representing a particular genetic mutation;
provide the first set of genomic information to each predictor of the plurality of predictors over the network;
obtain, over the network from the plurality of predictors, a first plurality of predictions, wherein a prediction of the first plurality of predictions predicts whether the first set of genomic information represents the particular genetic mutation;
provide, to a logistic regression model, the first plurality of predictions;
identify, to the logistic regression model, that the first plurality of predictions represents the particular genetic mutation;
obtain, from the logistic regression model, a coefficient for each prediction of the first plurality of predictions;
obtain a second set of genomic information;
provide the second set of genomic information to at least one predictor of the plurality of predictors over the network;
obtain, over the network from the plurality of predictors, a second plurality of predictions, wherein a prediction of the second plurality of predictions predicts whether the second set of genomic information represents the particular genetic mutation;
determine, based on the obtained plurality of coefficients and the obtained second plurality of predictions, whether the second set of genomic information represents the particular genetic mutation; and
transmit the determination via the network for display.

24. The system according to claim 23, wherein:
at least one of the plurality of predictors does not provide a prediction for the second plurality of genomic information.

25. The system according to claim 23, wherein:
the plurality of predictors consists of SIFT, MUTATIONASSESSOR, and GERP.

26. The system according to claim 23, wherein:
the plurality of predictors consists of SIFT, MUTATIONASSESSOR, LRT, MUTATIONTASTER, PHYLOP, and GERP.

27. The system according to claim 23, wherein:
the plurality of predictors comprises SIFT, MUTATIONASSESSOR, and GERP, but not CONDEL nor POLYPHEN.

28. The system according to claim 23, wherein:
the plurality of predictors comprises SIFT, MUTATIONASSESSOR, and GERP, but not CONDEL.

29. The system according to claim 23, wherein:
the plurality of predictors comprises SIFT, POLYPHEN, MUTATIONASSESSOR, and GERP, but not CONDEL.

30. The system according to claim 23, wherein:
the plurality of predictors comprises SIFT, POLYPHEN, MUTATIONASSESSOR, LRT, MUTATIONTASTER, PHYLOP, and GERP, but not CONDEL.

31. The system according to claim 23, wherein:
the particular genetic mutation is a harmful genetic mutation.

32. The system according to claim 23, wherein the one or more processors are further configured to:
obtain, via the network, the first set of genomic information representing the particular genetic mutation from an online database of human genes and genetic phenotypes.

33. The system according to claim 32, wherein:
the online database is the Online Mendelian Inheritance in Man database.
